(19) United States
(12) Patent Application Publication
(10) Pub. No.: US 2005/0099029 A1
(43) Pub. Date: May 12, 2005

(54) Two-handled shovel with hinge coupling

(76) Inventor: Peter M. Lerman, Bethel, CT (US)

Correspondence Address: SHERMAN D PERNIA, ESQ., PC, 1110 NASA ROAD ONE, SUITE 450, HOUSTON, TX, 77058-3310, US

(21) Appl. No.: 10/712,873

(22) Filed: Nov. 12, 2003

(51) Int. Cl. A01B 1/22

(52) U.S. Cl. 294/58

(57) ABSTRACT

A two-handled, manual shoveling device permits it user to stand relatively upright while engaged in shoveling activity. The shoveling device has a primary handle fixed at a one end to a tool head, such as a snow shovel head. One end of a secondary handle is connected to the primary handle proximate the tool head by a hinge coupling assembly. The hinge coupling assembly includes a swivel feature allowing the secondary handle to rotate relative to the primary handle. Additionally, the hinge coupling assembly has a release mechanism, such as a hinge pin. The release mechanism allows the secondary handle to be separated from the primary handle, and the primary handle and tool head to be used as a more conventional shoveling tool.

### FIELD OF THE INVENTION

The present invention is in the field of devices combined with handles and adapted for engaging materials for manipulating purposes. More specifically, the invention is in the field of such devices having tool heads for engaging materials, which include an auxiliary handle additional to the handle usually present on the device. In particular, the present invention relates to two-handled snow shovel with a hinge coupling to the auxiliary handle.

### BACKGROUND OF THE INVENTION

Hand held shoveling tools, particularly show shovels and the like, are well known in the art. It is recognized that a person engaged in shoveling activity using one of these tools can readily experience serious fatigue, and muscle and joint pain, especially in the back. Ostensively, the cause for this discomfort is the repetitive bending over that the shoveler is required to do in order to engage the shovel blade at foot level with the material to be lifted. Recognizing the repetitive bending over as the source of this problem, the field has been motivated to provide solutions such as the two-handled shovel.

Two-handled shoveling tools have been developed in the art to address this problem, typically by attempting to reduce the degree of bending over that a shoveler must do to accomplish the same work as with prior single straight handled shovels. A common feature of one type of two-handled shovels is a primary handle attached to the tool head (shovel blade) having an auxiliary or secondary handle attached to the primary handle. An example of a prior two-handled shove is disclosed in U.S. Pat. No. 4,128,266 to Vaslas. The Vaslas patent teaches a secondary handle that in use is fixed to a primary handle at two points along the length of the primary handle. However, the secondary handle of Vaslas is not movable relative to the primary handle during shoveling.

An improvement over the Vaslas is disclosed in U.S. Pat. No. 5,447,349 to Coble. The Coble patent teaches a secondary handle that in use is attached to a primary handle at only one point along the length of the primary handle. More specifically in Coble, one end of the secondary handle is connected to the primary handle proximate the tool head. Additionally in the Coble device, the means of attachment of the secondary to the primary handle allowed the secondary handle articulate relative to the primary handle. However, the ring means taught as a feature of the Coble secondary handle attachment means provides for a relatively loose or inexact coupling between the primary and secondary handles. An alternative to the Coble device having a less loose and more precise coupling between the primary secondary handles is disclosed in U.S. Pat. No. 6,283,522 to Renaud. The coupling between one end of the secondary handle to the primary handle taught by Renaud comprises a combination U-joint and screw swivel element. This coupling element potentially provides for a more secure and precise coupling and for smoother operation of a two-handled shovel by a user. However, the simple screw swivel component of the Renaud coupling element has the inherent risk of coming unthreaded and the secondary handle separating during use of the shovel.

A more secure mechanism for coupling one end of the secondary handle to the primary handle is disclosed in U.S. Pat. No. 5,133,582 to Rocha. The coupling mechanism between the one end of the secondary handle to the primary handle taught by Rocha comprises a combination bushing and screw swivel element. In the Rocka device, a rotatable bushing is retained proximate the tool end of the primary handle, with the bushing attached to the secondary handle by a swivel linkage. However, if a user desires to use the shovel without the secondary handle attached, the bushing component of the coupling element cannot be easily removed from the primary handle, especially if the primary handle terminates in a T-grip as shown in the Rocha patent. An alternative two-handled shovel also utilizing a bushing component in the mechanism coupling the first end of the secondary handle to the primary handle is disclosed in U.S. Pat. No. 6,062,619 to Clark, Jr. The coupling element of the Clark device comprises the combination of an externally threaded sleeve (bushing) and a complimentary threaded adjustment nut. The adjustment nut has pivot mounts fixed on it, and the nut is nut is positionable along the length of the threaded sleeve. The pivot mounts provide means for pivotably attaching the secondary to the adjustment nut. The Clark two-handled shovel includes the feature of having the secondary grip end of the secondary handle be positionable relative to the grip end of the primary handle to accommodate different size users. However, the maximum mechanical advantage is accomplished when the attachment point of the secondary handle is close to the tool head. Moving the attachment point away from the tool head diminishes the mechanical advantage of the lever formed by the user's grip on the primary handle and the lifting point as the attachment (lifting) point is moved away from the tool head. Therefore, when the attachment point of the secondary handle is moved away from the tool head, a greater force must be used to lever a given load than when the attachment point is close to the tool head. Therefore, moving the attachment point away from the tool head may not be beneficial to shorter user's of the Clark device.

Although the above devices each may be useful for its intended purpose, it would be beneficial to the field to have an alternative two-handled shovel which overcomes these limitations.

### SUMMARY OF THE INVENTION

The present invention is a two-handled, manual shoveling tool. In a preferred embodiment, the present invention is a two-handled show shovel. The two-handled feature of the present invention allows a user to stand relatively upright while using the tool. This can reduce the back fatigue a user may experience while engaging in shoveling activities.

The present two-handled shoveling tool has a primary handle fixed at a first end to a tool head, preferably a snow shovel type tool head. The other end of the primary handle can be formed to include a hand grip to accommodate the grasp of a user, or can be adapted to receive a grip handle. A secondary handle is detachably connected by its first end to the primary handle, proximate the tool head. The other end of the secondary handle can also be formed to include a hand grip to accommodate the grasp of a user, or can be adapted to receive a grip handle. A detachable coupling assembly connects the secondary handle to the primary handle. The coupling assembly can be readily separable into two section, or can be completely detachable from the primary handle.

The detachable hinge coupling assembly, as its name implies, has a release mechanism. The release mechanism allows the secondary handle to be separated from the primary handle, and the primary handle and tool head to be used as a more conventional shoveling tool. The separated section of the assembly remaining with the primary handle has no loose parts to rattle or move as the tool is being used in the conventional fashion. In a preferred embodiment, the detachable coupling assembly was a hinge-type coupling. In this embodiment, the hinge base plate was mounted on the primary handle using removable screw fasteners. Other means or fasteners useful for mounting the base plate to a handle of the present invention are known to an selectable by one of ordinary skill in the art for practice in the present invention. A hinge plate was pivotably (or hingeably) connected to the base plate (stationary member) by a hinge pin. The hinge pin was removable, and allowed for connecting and disconnecting the hinge plate to and from the base plate.

The hinge plate in turn connected to the first end of the secondary handle. The connection of the secondary handle to the hinge plate was accomplished using a swivel assembly. The swivel assembly comprised first and second swivel members connected by a swivel pivot/engagement means. The first swivel member comprised a portion of the hinge plate. The second swivel member extended from the first end of the secondary handle. In this embodiment, the engagement means was a fastener connecting the first and second swivel members in a common plane of rotation relative to each other.

Optionally, the primary handle of the present invention is adjustable in length (rather than the secondary handle) if it is desirable to provide a tool that is adjustable for shorter users. Alternatively, an adjustable length means may be practiced on the secondary handle as well, so long as the attachment point of the secondary handle to the primary handle is not moved away from the tool head.

### BRIEF DESCRIPTION OF THE DRAWINGS

FIG. 1 illustrates the present two-handled shovel with the secondary handle in a stored configuration.

FIG. 2 illustrates the present two-handled shovel with the secondary handle in a free configuration.

FIG. 3 is a close-up view of the hinge coupling assembly of the present two-handled shovel with the secondary handle in a free configuration.

FIGS. 4A and 4B are a top plan and a cross-sectional view respectively of a section of the shaft of the primary handle of the present two-handled shovel.

FIGS. 5A and 5B are a top plan and a cross-sectional view respectively of the end section of the shaft of the secondary handle of the present two-handled shovel.

FIGS. 6A and 6B are a top plan and corresponding end views, and 6C is a side elevation view of the swivel member mounted at the end of the secondary handle.

FIGS. 7A and 7B are a top plan and corresponding end views, and 7C is a side elevation view of one of a pair of base plates of a hinge coupling assembly mounted on the primary handle.

FIGS. 8A and 8B are a top plan and corresponding end views, and 8C is a side elevation view of a hinge plate of a hinge coupling assembly mounted on the primary handle.

FIGS. 9A and 9B are a top plan and corresponding end views, and 9C is a side elevation view of a hinge coupling assembly of the present invention shown mounted on the primary handle and connecting to the secondary handle.

FIG. 10 is a close-up view of an alternative embodiment of the hinge coupling assembly of the present two-handled shovel with the secondary handle in a free configuration.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

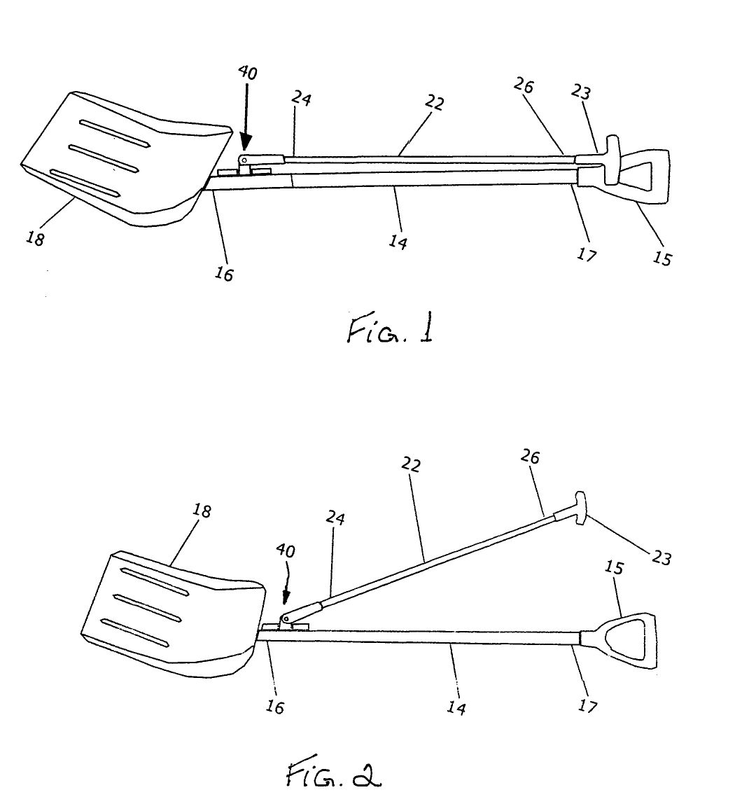

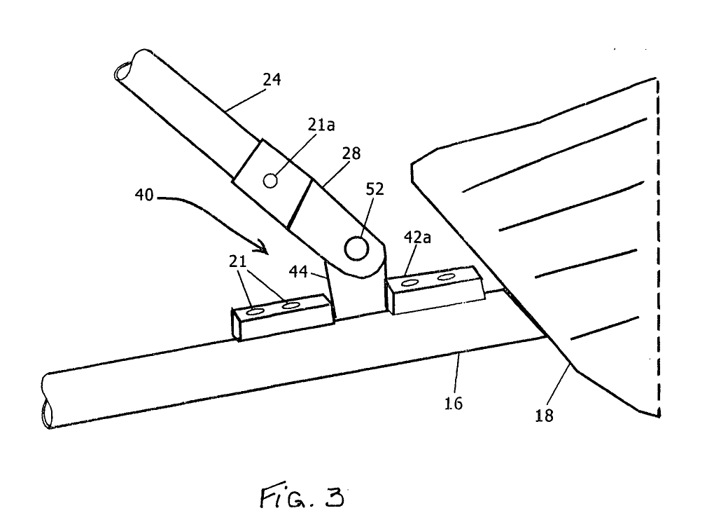

As shown in FIGS. 1 and 2, the two-handled shoveling tool 10 comprises a primary handle 14 having a first tool end 16 to which a tool head 18 is fixed. A secondary or auxiliary handle 22 is detachably connected at a first hinge end 24 to the primary handle 14 proximate the tool head 18. As shown in FIGS. 3 and 10, a hinge coupling assembly 40 detachably connects the secondary handle 22 to the primary handle 14. The combination of the two handles in the present invention 10 facilitates the use of a shoveling tool while reducing the bending over a user ordinarily would need to do to accomplish a typical shoveling task, such as removing snow from a walkway. Additionally, the secondary handle 22 can be removed from the device 10 to enable its use as a shoveling tool in the typical manner.

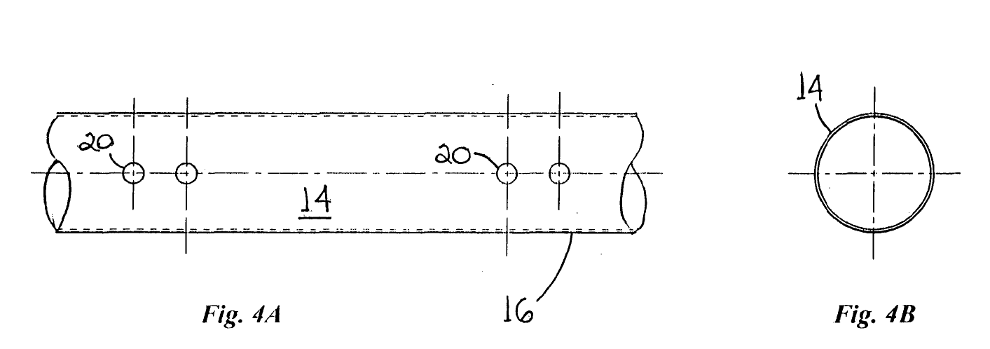

In the preferred embodiment shown in FIGS. 1-3, and particularly illustrated in FIGS. 4A and 4B, the primary handle 14 of the present shoveling tool 10 was a metal tube. Other materials suitable for practice as the primary handle 14 are known to and selectable by one of ordinary skill in the art. For example, the primary handle 14 may be constructed of wood (see FIG. 10), plastic or other suitable material. Proximate the tool end 16 of the primary handle 14, means are provided by which the hinge coupling assembly 40 is attached to the primary handle 14. In the preferred embodiment shown in FIG. 4, the attachment means are fastener holes 20, which coincide with a preferred embodiment of the hinge coupling assembly 40. However, other attachment means are known to and practicable in the present invention by the ordinary skilled artisan.

In the embodiment shown in FIGS. 1 and 2, the primary handle 14 includes an optional primary hand grip 15 attached to its distal end 17. The configuration of the primary hand grip 15 is not a part of the present invention, only that the primary handle 14 be graspable by a user. Also shown in various figures is a tool head 18 that is a shovel scoop or blade. The ordinary skilled artisan will appreciate and it is intended that the configuration shown for the tool head 18 is not to limit the scope of the present invention and that other configurations of a shovel blade (indeed, other altogether different tool heads 18, e.g., a fork) are practicable with the present invention.

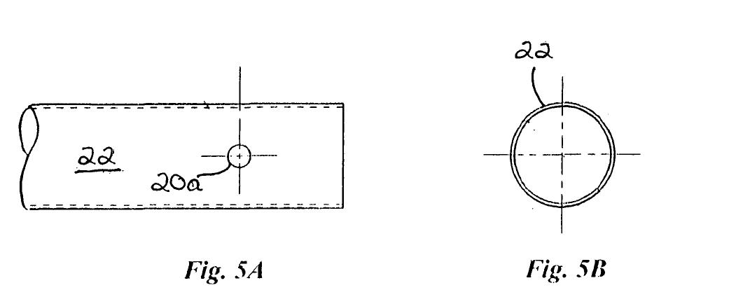

In the preferred embodiment shown in FIGS. 1-3, and particularly illustrated in FIGS. 5A and 5B, the secondary handle 22 of the present shoveling tool 10 was a metal tube. Other materials suitable for practice as the secondary handle 22 are known to and selectable by one of ordinary skill in the art. For example, the secondary handle 2 may be constructed of wood, plastic (see FIG. 10) or other suitable material. Proximate the hinge end 24 of the secondary handle 22, means are provided by which the hinge coupling assembly 40 is attached to the secondary handle 22. In the preferred embodiment shown in FIGS. 5A-5B, the attachment means comprises fastener holes 20a and a handle swivel member 28. The handle swivel member 28 in a preferred embodiment is a formed plug that was partially inserted into the tube lumen of the secondary handle 22 and held in place with a fastener 21a.

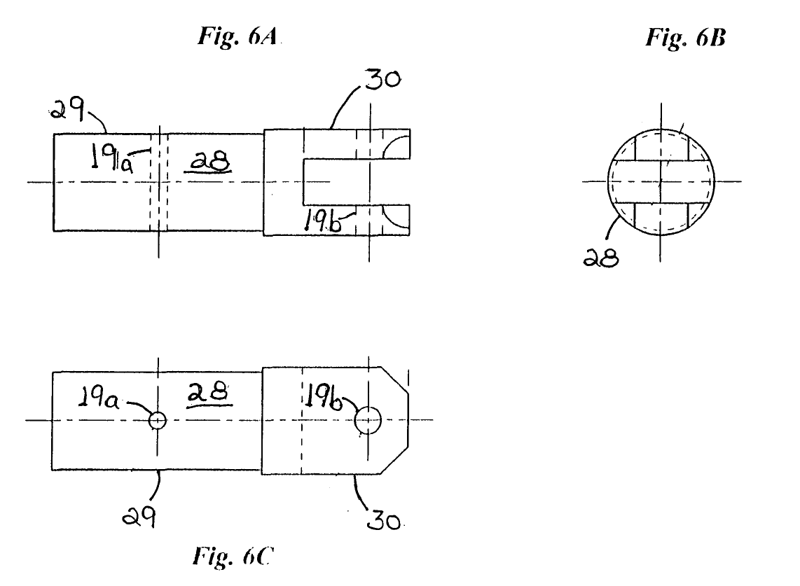

The swivel member 28 has a plug end 29 and a receiver end 30. In one preferred embodiment, the plug end 29 inserts into the tube lumen of the secondary handle 22 and positioned to have its through hole 19a align with the fastener hole 20a of the secondary handle 22 (see FIGS. 5A-6C). A handle fastener 21a is used to hold the plug end 29 in place. The receiver end 30 of the swivel member 28 corresponds to swivel attachment member 44 of the hinge coupling assembly 40, including having a corresponding through hole 19b. However, other attachment mechanisms are known to and practicable in the present invention by the ordinary skilled artisan. For example, in the preferred embodiment shown in FIG. 3, the plug end 29 of the swivel member 28 received the hinge end 24 of the secondary handle 22, and an expansion pin type fastener 21a was used to hold the plug end 29 in place.

In the preferred embodiment shown in FIGS. 1 and 2, the secondary handle 22 (as is the case with the primary handle) includes an optional secondary hand grip 23 attached to its distal end 26. The a specific configuration for the secondary hand grip 26 is not a part of the present invention, only that the secondary handle 22 be graspable by a user.

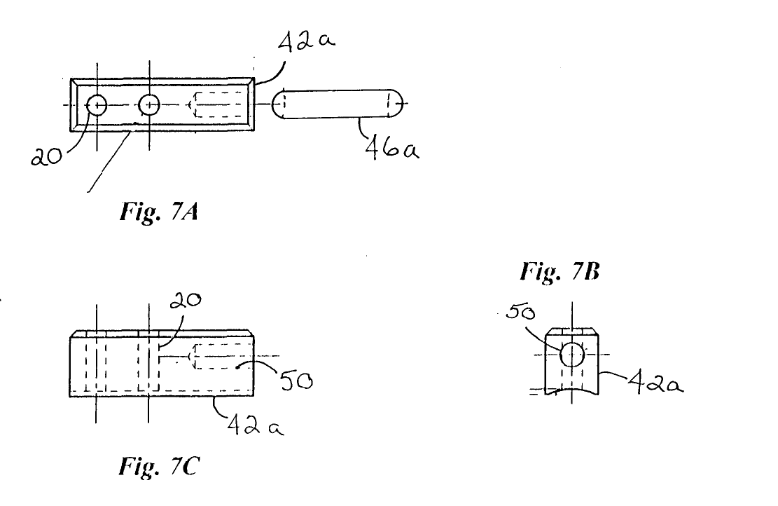

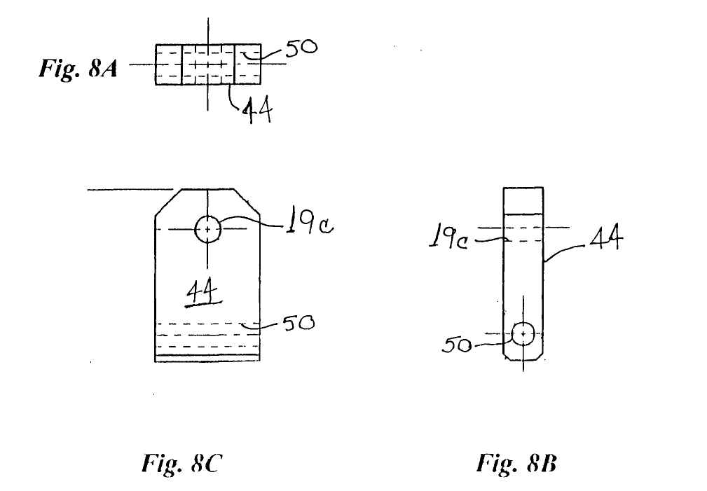

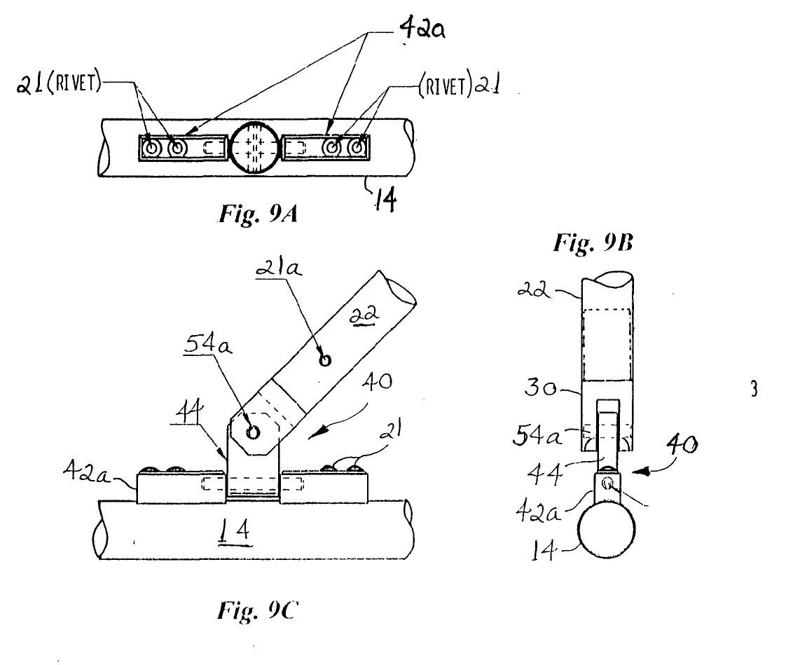

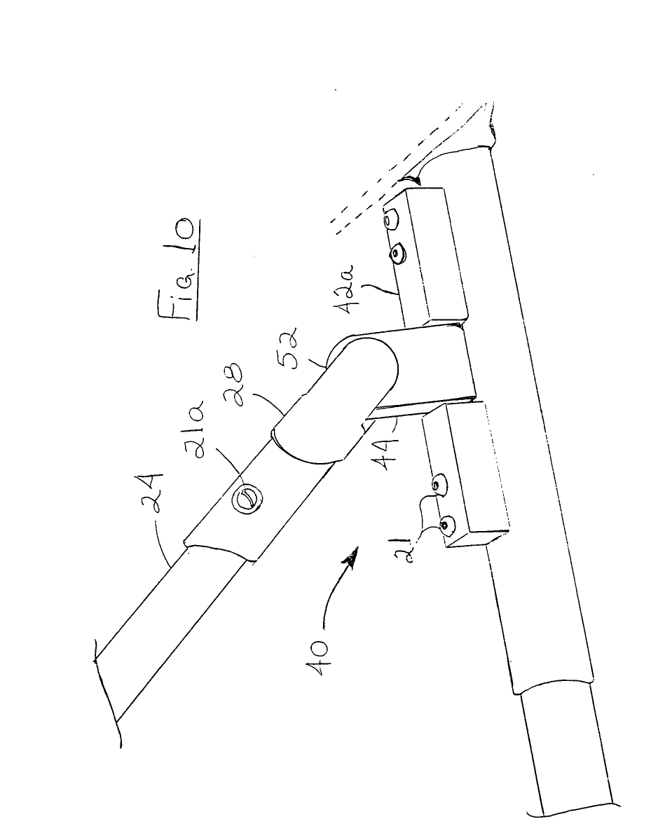

As illustrated in FIGS. 3 and 10, the present two-handled shovel 10 includes a hinge coupling assembly 40. See also FIGS. 7A-9C. The hinge coupling assembly 40 comprises a hinge plate 44 hingeably mounted on the primary handle 14, and attached to the handle swivel member 30 of the secondary handle 22. The hinge coupling assembly 40 has a base or mounting plate(s) 42 by which the assembly 40 is hingeably mounted on the primary handle 14. A base fastener means 21 is used to attach the base plate 42 to the primary handle 14. Other means for mounting the base plate 42 to the primary handle are known to and practicable in the present invention by one of ordinary skill in the art (e.g., ring clamps, welding, etc.). The hinge plate 44 is hingeably connected to the base plate 42 (the stationary member of the hinge coupling assembly 40) by a hinge pin 46. Additionally, the hinge plate 44 has a swivel connection 52 which couples the hinge assembly 40 to the swivel member 30 of the secondary handle 22. The swivel connection 52, in the embodiments shown, comprises a swivel through hole 19c on the hinge plate 44 which corresponds to the swivel member through hole(s) 19b on the swivel member 30 of the secondary handle 22. A swivel fastener 54 aligns and passes through the through holes 19b & 19c, and joins the swivel member 30 of the secondary handle 22 to the hinge coupling assembly 40. The swivel fastener 54 provides an engagement means connecting the swivel member 30 of the secondary handle 22 to the hinge coupling assembly 40 in a common plane of rotation relative to each other.

In the preferred embodiment illustrated in FIG. 10, the hinge pin 46 was removable from the hinge pin bore 50. This feature allowed the secondary handle 22 and part of the hinge coupling assembly 40 to be separated from the primary handle 14. This enabled the primary handle 14 and tool head 18 combination of the present tool 10 to be used in a more conventional manner. Alternatively, as illustrated in FIGS. 7A-9C, the hinge pin 46a may be retained in the pin bore 50 in a captive manner. Also in a preferred embodiment, the fasteners 21 were removable, allowing the entire hinge coupling assembly 40 to be removed from the primary handle 14 (e.g., see FIG. 10).

Optionally, it is preferred that both the primary handle 14 and the secondary handle 22 of the present invention be adjustable in length (not shown) if it is desirable to provide a tool that is adjustable for shorter users. Means for accomplish adjustable length handles are know to and practicable in the present invention by one of ordinary skill in the art, so long as the attachment point of the secondary handle 22 to the primary handle 14 is not moved away from the tool head 18.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

1. A two-handled shoveling tool comprising:
a primary handle fixed at a tool end to a tool head;
a secondary handle detachably connected at a first end to the primary handle proximate the tool head; and
a hinge coupling assembly detachably connecting the secondary handle to the primary handle.

2. The two-handled shovel of claim 1, wherein the hinge coupling assembly further comprises:
a hinge means mounted on the primary handle; and
a handle swivel means connecting the secondary handle to the hinge means.

3. The hinge coupling assembly of claim 2, wherein the hinge means comprises:
a base plate;
a first fastener means mounting the base plate to the primary handle;
a hinge plate, the hinge plate hingeably connected to the base plate and having a first swivel member disposed thereon; and
a removable hinge pin for hingeably connecting and disconnecting the base plate with the hinge plate.

4. The hinge coupling assembly of claim 2, wherein the handle swivel means comprises:
a second swivel member mounted at the first end of the secondary handle; and
an engagement means, connecting the first and second swivel members in a common plane of rotation relative to each other.

5. The two-handled shoveling tool of claim 1, wherein the primary handle is adjustable in length.

6. The two-handled shoveling tool of claim 1, wherein the secondary handle is adjustable in length.
